(19) United States
(12) Patent Application Publication
(10) Pub. No.: US 2012/0191567 A1
(43) Pub. Date: Jul. 26, 2012

(54) EXPRESS PURCHASE SYSTEMS AND METHODS

(76) Inventors: Naomi Williams, Durham, NC (US); Carol Taylor, Woodinville, WA (US); Michael Pace, Maple Valley, WA (US); Lee Fergestrom, Sammamish, WA (US); John Hardi, Sammamish, WA (US)

(21) Appl. No.: 13/281,855

(22) Filed: Oct. 26, 2011

Related U.S. Application Data
(60) Provisional application No. 61/406,898, filed on Oct. 26, 2010.

(51) Int. Cl. G06Q 30/06; G06Q 20/14; G06Q 30/04

(52) U.S. Cl. 705/26.8

(57) ABSTRACT

Techniques for single-action transactions initiated by a mobile device are described. Example embodiments provide a mobile marketplace system (“MMS”) configured to provide a marketplace for items that is accessible via mobile devices. The MMS facilitates single-action transactions (e.g., single click, single selection) for electronic goods, such as ringtones, music, videos, or the like. In some embodiments, single-action transactions are facilitated without requiring one or more of account pre-registration (e.g., setup of an account with username, credit card, or the like), account login (e.g., username/password), a separate credit card account, or a shopping cart.

### PRIORITY CLAIM

This application claims the benefit of U.S. Provisional Application Ser. No. 61/406,898 filed Oct. 26, 2010, the contents of which are incorporated by reference.

### FIELD OF THE INVENTION

The field of the invention is electronic marketplaces for mobile devices and, more particularly, facilitating single-action transactions for goods or services by users of mobile devices.

### BRIEF DESCRIPTION OF THE DRAWINGS

Preferred and alternative examples of the present invention are described in detail below with reference to the following drawings:

FIG. 1 is a block diagram of an example computing system for implementing a mobile marketplace system according to an example embodiment.

FIG. 2 is a flow diagram of an express purchase process performed in a first example embodiment.

FIG. 3 is a flow diagram of an express purchase process performed in a second example embodiment.

FIG. 4 is a flow diagram of an express purchase process performed in a third example embodiment.

FIGS. 5A-5C are example user interface screens presented during example express purchases according to various embodiments.

### DETAILED DESCRIPTION

Embodiments described herein provide enhanced computer- and network-based methods and systems for facilitating single-action transactions initiated by a mobile device. Example embodiments provide a mobile marketplace system (“MMS”) configured to provide a marketplace for items that is accessible via mobile devices. In one embodiment, the MMS facilitates single-action transactions (e.g., single click, single selection) for electronic goods such as ringtones, music, videos, or the like. Single-action transactions are herein also called “express purchase transactions” and are provided by an “express purchase facility.” Items that may be made available via the marketplace include tangible and/or intangible goods and services, including but not limited to, digital media/information (e.g., audio files, video files, text files, electronic books), tangible goods (e.g., clothing, toys, sporting equipment), and services (e.g., financial services, travel services). An example embodiment of an MMS is described below in the section entitled “mCore Storefront Description.”

The express purchase facility provided by example embodiments of the MMS is a streamlined purchase process that significantly reduces the burden for consumers attempting to purchase goods and services via a mobile device. Unlike currently options that require pre-registration to setup accounts, the usage of credit cards, or lengthy checkout processes (e.g., shopping carts, multiple confirmation screens), the express purchase facility leverages trusted carrier relationships and previously established subscriber accounts and billing methods to complete a purchase with one push of a button. The express purchase facility does not require account pre-registration (e.g., setup of an account with username, credit card, or the like), account login (e.g., username/password), a separate credit card account, or a shopping cart. The express purchase facility can be used in various contexts including purchasing content from a carrier marketplace, a carrier affiliate market (e.g., Android Market, GetJar, EA Mobile), an authorized third-party or “off-deck” merchant (e.g., Facebook, MySpace), a retail partner (e.g., Target, Wal-Mart), a point-of-sale system (e.g., NFC, Bluetooth, 2D/3D barcodes), or the like. Generally, the express purchase facility can be used by or provide benefits to various entities, including mobile carriers (e.g., who sell ringtones or other types of content), bricks and mortar and/or online retail companies (e.g., who sell tangible or intangible goods or services via the facility), media and entertainment companies, travel companies, financial companies (e.g., banks, investment firms), and the like.

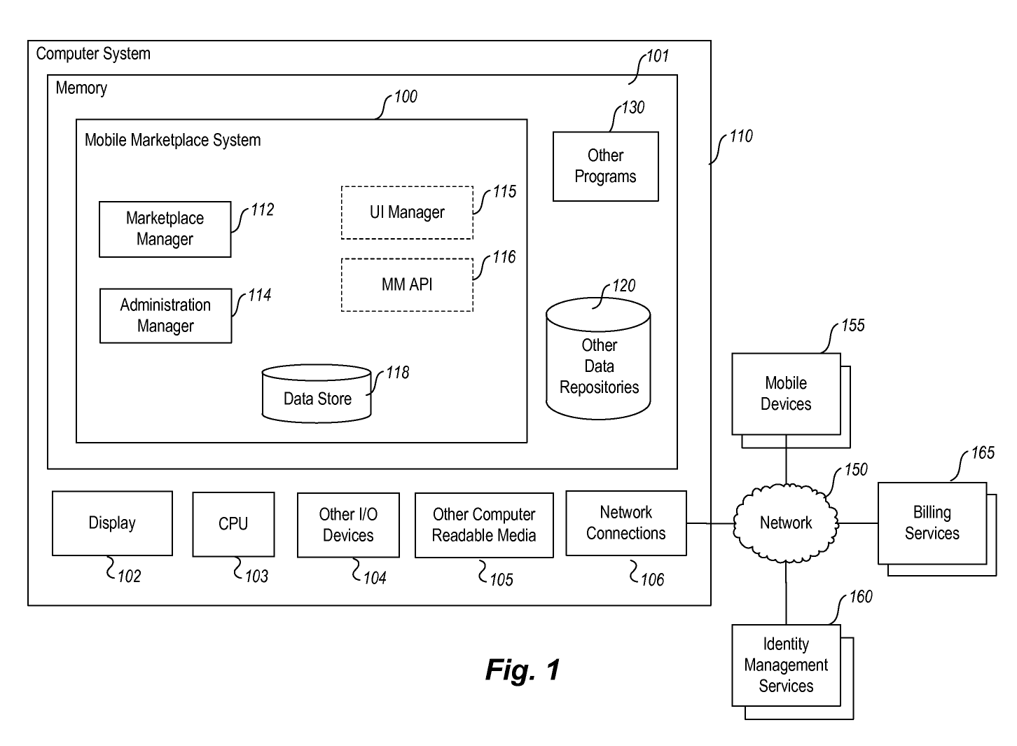

FIG. 1 is a block diagram of an example computing system for implementing a MMS according to an example embodiment. In particular, FIG. 1 shows a computing system 110 that may be utilized to implement a MMS 100.

Note that one or more general purpose or special purpose computing systems/devices may be used to implement the MMS 100. In addition, the computing system 110 may comprise one or more distinct computing systems/devices and may span distributed locations. Furthermore, each block shown may represent one or more such blocks as appropriate to a specific embodiment or may be combined with other blocks. Also, the MMS 100 may be implemented in software, hardware, firmware, or in some combination to achieve the capabilities described herein.

In the embodiment shown, computing system 110 comprises a computer memory (“memory”) 101, a display 102, one or more Central Processing Units (“CPU”) 103, Input/Output devices 104 (e.g., keyboard, mouse, CRT or LCD display, and the like), other computer-readable media 105, and network connections 106 connected to a network 150. The MMS 100 is shown residing in memory 101. In other embodiments, some portion of the contents, some or all of the components of the MMS 100 may be stored on and/or transmitted over the other computer-readable media 105. The components of the MMS 100 preferably execute on one or more CPUs 103 and manage subscriptions as described herein. Other code or programs 130 (e.g., an administrative interface, a Web server, and the like) and potentially other data repositories, such as data repository 120, also reside in the memory 101, and preferably execute on one or more CPUs 103. Of note, one or more of the components in FIG. 1 may not be present in any specific implementation. For example, some embodiments may not provide other computer readable media 105 or a display 102.

The MMS 100 includes a marketplace manager 112, an administration manager 114, and a data store 118. The MMS 100 may also include a user interface manager 115 and a mobile marketplace system application program interface (“API”) 116. The UI manager 115 and API 116 are drawn in dashed lines to emphasize that in other embodiments, functions performed by one or more of these components may be performed externally to the MMS 100.

The marketplace manager 112 generally performs user-accessible functions for or on behalf of users operating mobile devices 155. In one embodiment, the marketplace manager 112 facilitates single-action transactions for users of mobile devices 155, by automatically interacting with billing services 165 and identity management services 160 to provide an efficient, convenient, and seamless user experience. Additional functions that may be performed by the marketplace manager 112 may include providing content, providing search facilities, providing shopping facilities (e.g., online catalogs), and the like. Example functions that may be performed by the marketplace manager 112 in some embodiments are described further below in the section entitled “mCore Storefront” Description.”

The administration manager 114 generally performs administrative functions, such as user management, content management, catalog management, merchandising, and the like.

The UI manager 115 provides a view and a controller that facilitate user interaction with the MMS 100 and its various components. For example, the UI manager 115 may provide interactive access to the MMS 100 such that users can perform transactions, obtain content, initiate searches, and the like. In some embodiments, access to the functionality of the UI manager 115 may be provided via a Web server, possibly executing as one of the other programs 130. In such embodiments, a user operating a Web browser (or other client) executing on one of the mobile devices 155 can interact with the MMS 100 via the UI manager 115.

The API 116 provides programmatic access to one or more functions of the MMS 100. For example, the API 116 may provide a programmatic interface to one or more functions of the MMS 100 that may be invoked by one of the other programs 130 or some other module. In this manner, the API 116 facilitates the development of third-party software, such as user interfaces, plug-ins, news feeds, adapters (e.g., for integrating functions of the MMS 100 into Web applications), and the like. In addition, the API 116 may be in at least some embodiments invoked or otherwise accessed via remote entities, such as one of the billing services 165, to access various functions of the MMS 100. For example, one of the billing services 165 may obtain transaction information via the API 116.

The data store 118 is used by the other modules of the MMS 100 to store and/or communicate information. The components of the MMS 100 use the data store 118 to record various types of information, including content, information about users, transaction information, and the like. Although the components of the MMS 100 are described as communicating primarily through the data store 118, other communication mechanisms are contemplated, including message passing, function calls, pipes, sockets, shared memory, and the like.

The MMS 100 interacts via the network 150 with mobile devices 155, identity management services 160, and billing services 165. The network 150 may be any combination of media (e.g., twisted pair, coaxial, fiber optic, radio frequency), hardware (e.g., routers, switches, repeaters, transceivers), and protocols (e.g., TCP/IP, UDP, Ethernet, Wi-Fi, WiMAX) that facilitate communication between remotely situated humans and/or devices. In some embodiments, the network 150 may be or include multiple distinct communication channels or mechanisms. For example, the MMS 100 may communicate via a cellular telephone network with the mobile devices 155, while communicating via some other network (e.g., a dedicated/private network, the Internet, etc.) with the billing services 165 and/or the identity management services 160. The mobile devices 155 include mobile phones, smart phones, personal digital assistants, laptop computers, tablet computers, and the like. In other embodiments, other types of computing devices may be used to initiate express purchases, including desktop computers, kiosk computers, and the like.

In an example embodiment, components/modules of the MMS 100 are implemented using standard programming techniques. For example, the MMS 100 may be implemented as a “native” executable running on the CPU 103, along with one or more static or dynamic libraries. In other embodiments, the MMS 100 may be implemented as instructions processed by a virtual machine that executes as one of the other programs 130. In general, a range of programming languages known in the art may be employed for implementing such example embodiments, including representative implementations of various programming language paradigms, including but not limited to, object-oriented (e.g., Java, C++, C#, Visual Basic.NET, Smalltalk, and the like), functional (e.g., ML, Lisp, Scheme, and the like), procedural (e.g., C, Pascal, Ada, Modula, and the like), scripting (e.g., Perl, Ruby, Python, JavaScript, VBScript, and the like), and declarative (e.g., SQL, Prolog, and the like).

The embodiments described above may also use either well-known or proprietary synchronous or asynchronous client-server computing techniques. Also, the various components may be implemented using more monolithic programming techniques, for example, as an executable running on a single CPU computer system, or alternatively decomposed using a variety of structuring techniques known in the art, including but not limited to, multiprogramming, multithreading, client-server, or peer-to-peer, running on one or more computer systems each having one or more CPUs. Some embodiments may execute concurrently and asynchronously, and communicate using message passing techniques. Equivalent synchronous embodiments are also supported. Also, other functions could be implemented and/or performed by each component/module, and in different orders, and by different components/modules, yet still achieve the described functions.

In addition, programming interfaces to the data stored as part of the MMS 100, such as in the data store 118, can be available by standard mechanisms such as through C, C++, C#, and Java APIs; libraries for accessing files, databases, or other data repositories; through scripting languages such as XML; or through Web servers, FTP servers, or other types of servers providing access to stored data. The data store 118 may be implemented as one or more database systems, file systems, or any other technique for storing such information, or any combination of the above, including implementations using distributed computing techniques.

Different configurations and locations of programs and data are contemplated for use with techniques described herein. A variety of distributed computing techniques are appropriate for implementing the components of the illustrated embodiments in a distributed manner including but not limited to TCP/IP sockets, RPC, RMI, HTTP, Web Services (XML-RPC, JAX-RPC, SOAP, and the like). Other variations are possible. Also, other functionality could be provided by each component/module, or existing functionality could be distributed amongst the components/modules in different ways, yet still achieve the functions described herein.

Furthermore, in certain embodiments, some or all of the components of the MMS 100 may be implemented or provided in other manners, such as at least partially in firmware and/or hardware, including but not limited to one or more application-specific integrated circuits (“ASICs”), standard integrated circuits, controllers executing appropriate instructions, and including microcontrollers and/or embedded controllers, field-programmable gate arrays (“FPGAs”), complex programmable logic devices (“CPLDs”), and the like. Some or all of the system components and/or data structures may also be stored as contents (e.g., as executable or other machine-readable software instructions or structured data) on a computer-readable medium (e.g., as a hard disk; a memory; a computer network or cellular wireless network or other data transmission medium; or a portable media article to be read by an appropriate drive or via an appropriate connection, such as a DVD or flash memory device) so as to enable or configure the computer-readable medium and/or one or more associated computing systems or devices to execute or otherwise use or provide the contents to perform at least some of the described techniques. Some or all of the system components and/or data structures may be stored as non-transitory content on one or more tangible computer-readable mediums. Some or all of the system components and data structures may also be stored as data signals (e.g., by being encoded as part of a carrier wave or included as part of an analog or digital propagated signal) on a variety of computer-readable transmission mediums, which are then transmitted, including across wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of this disclosure may be practiced with other computer system configurations.

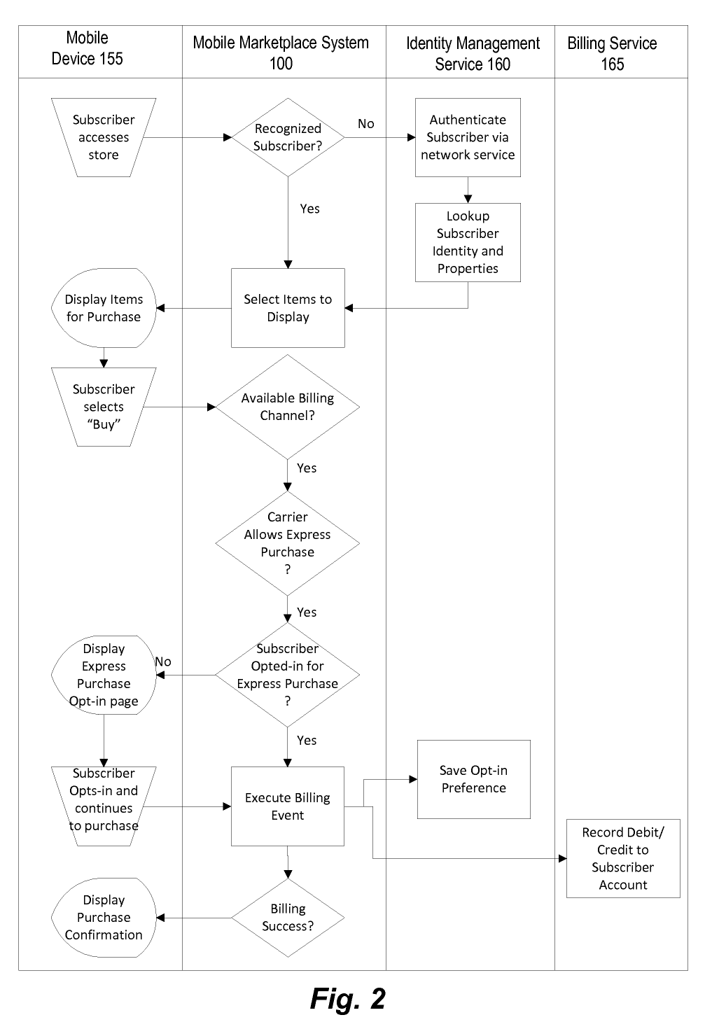

FIG. 2 is a flow diagram of an express purchase process performed in a first example embodiment. In particular, FIG. 2 illustrates operations performed by a mobile device 155, the MMS 100, the identity management service 160, and the billing service 165, described with respect to FIG. 1.

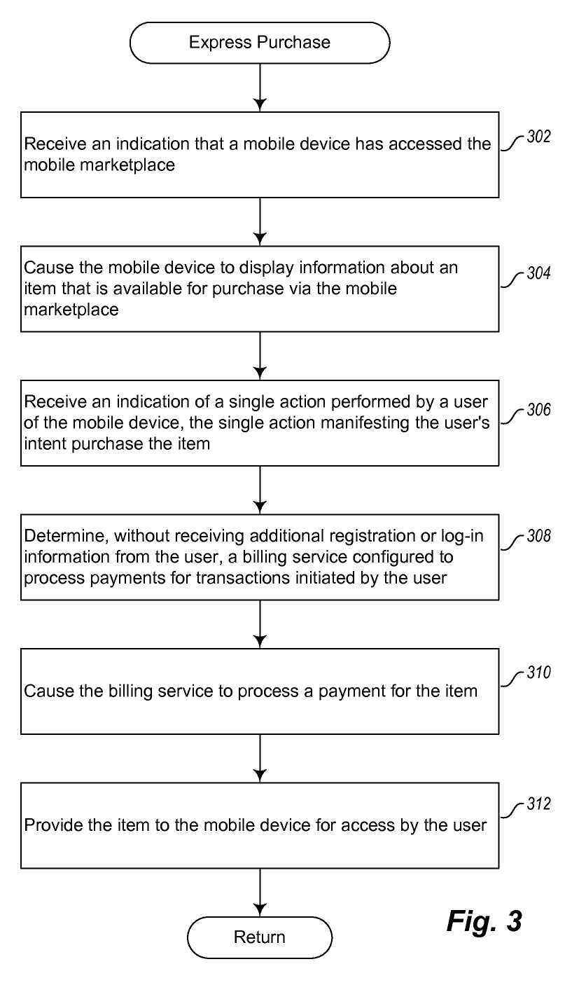

FIG. 3 is a flow diagram of an express purchase process performed in a second example embodiment. The illustrated process may be performed by the marketplace manager 112 and/or one of the mobile devices 155 described with respect to FIG. 1.

The process begins at block 302, where it receives an indication that a mobile device has accessed the mobile marketplace. The mobile marketplace may be, for example, presented via a Web browser or other client executing on the mobile device. Access to the mobile marketplace may thus be indicated by launching the Web browser or other action taken by the user (e.g., clicking on a link, pressing a button).

At block 304, the process causes the mobile device to display information about an item that is available for purchase via the mobile marketplace. When the mobile marketplace is accessed via a Web browser, displaying information about the item includes presenting or transmitting a page or other data that represents information about the item. As discussed above, various types of items may be available via the mobile marketplace including, but not limited to, an application or computer program, a game, a ringtone, a ringback tone, a wallpaper, a video, a user interface theme, a content bundle, a carrier service, an event ticket, a travel ticket, a book, an item of clothing, a storage medium (e.g., compact disc), a food item, an electronics item (e.g., a mobile phone, a media player), or the like. In some cases, tangible goods offered by a retail entity may be offered for sale such that the user can obtain or pick up the item when they are physically present at the retail entity.

At block 306, the process receives an indication of a single action performed by a user of the mobile device, the single action manifesting the user's intent purchase the item. Receiving the indication of the single action may include receiving an indication that a some input, action, or gesture was made by the user via some user interface control, such as link, a button, a menu item, a touch screen, a device motion, an accelerometer, or the like.

At block 308, the process determines, without receiving additional registration or log-in information from the user, a billing service configured to process payments for transactions initiated by the user. Various types of billing services are contemplated, including pre-paid accounts, subscription club accounts, credit card processors, wireless billing services (e.g., a wireless carrier service associated with the user), and the like. The process (or associated modules) maintains a linkage between the user and one or more billing services, such that the user need not re-enter any additional authenticating information such as a username/password, account number, or the like.

At block 310, the process causes the billing service to process a payment for the item. Processing payment for the item depends at least in part on the type of billing service used. If the billing service is a pre-paid or subscription club, then money or credits may be deducted from the account. If the billing service is based on the user's wireless billing account, then charges may be added to the user's wireless bill.

At block 312, the process provides the item to the mobile device for access by the user. The manner in which the item is provided is based at least in part on the item. If the item is a digital media item such as a ringtone, song, or wallpaper, the item may be transmitted to the mobile device. If the item is a tangible good, then various delivery mechanisms are contemplated. In some circumstances, such as when the purchase is made at or near a retail location that deals in the type of item purchased, the user may be instructed to pick up the good at that retail location. In other cases, the item may be shipped to the user's home or other some other address associated with or provided by the user.

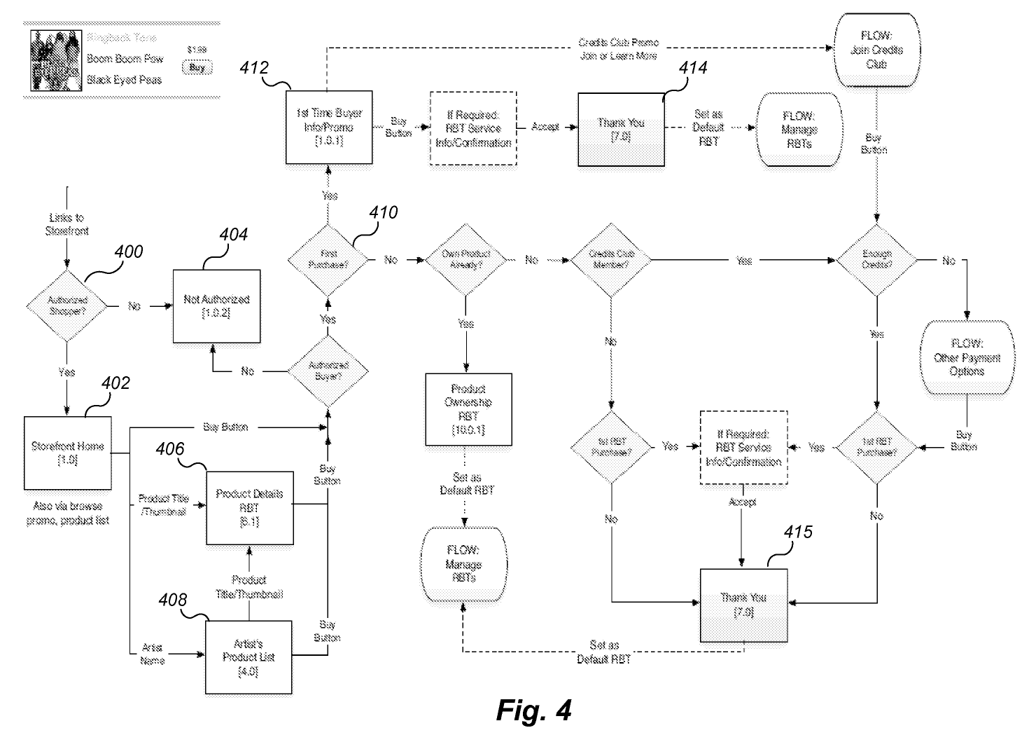

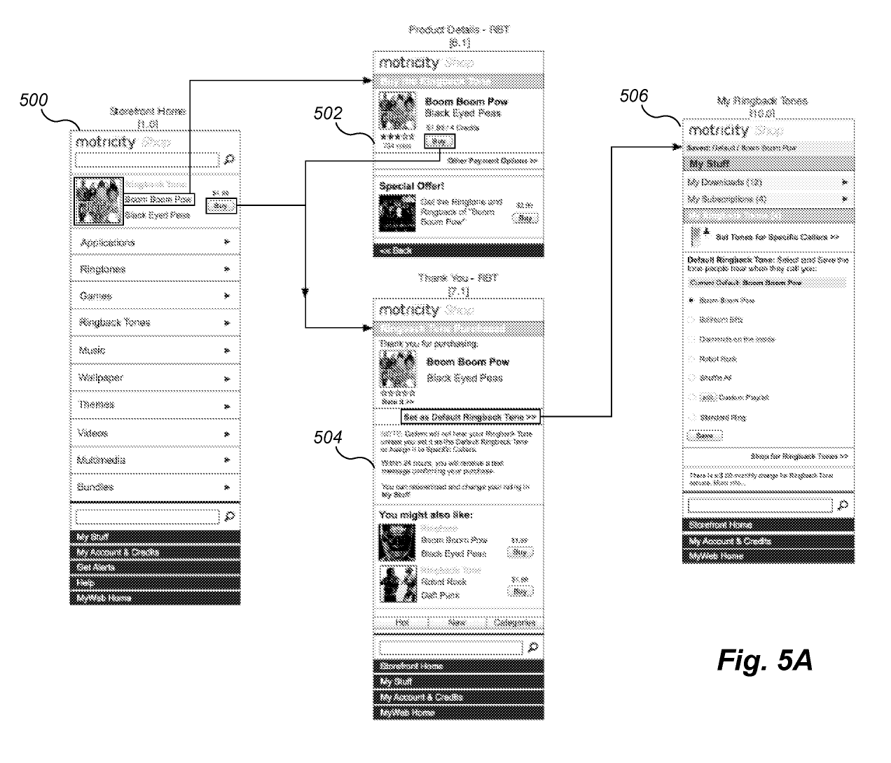

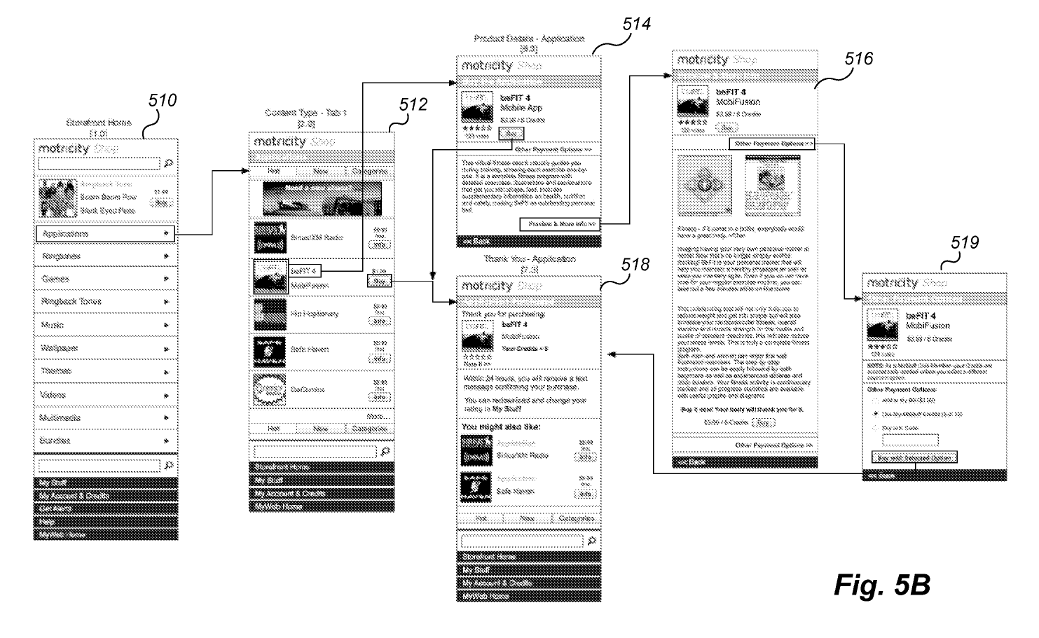

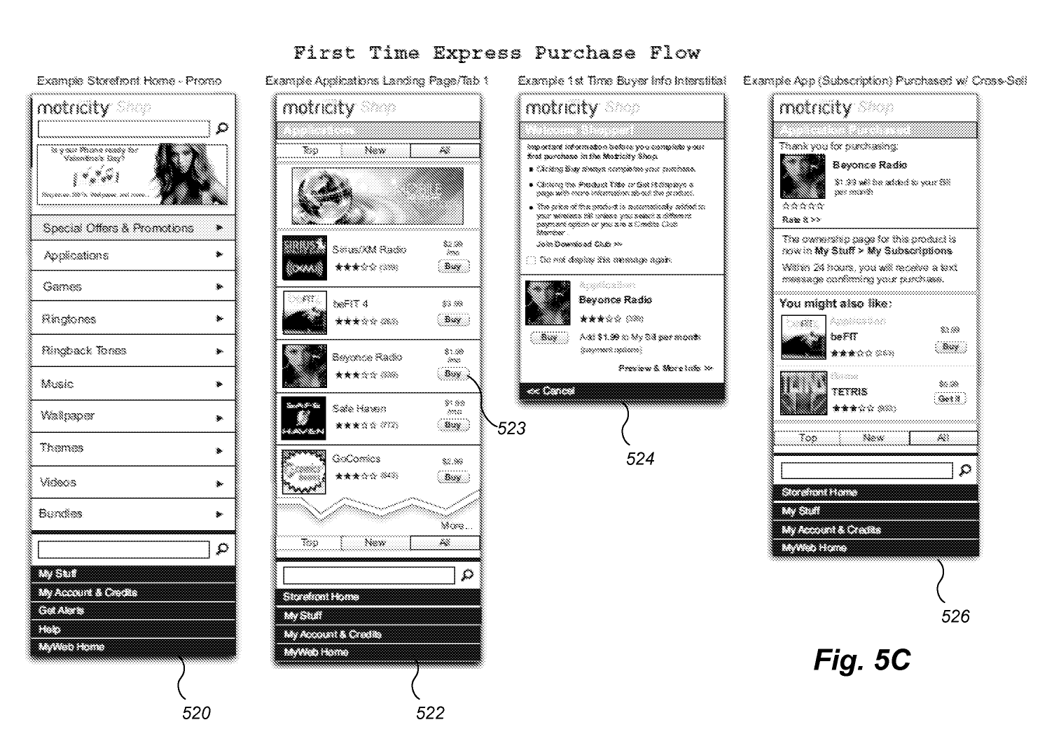

FIG. 4 is a flow diagram of an express purchase process performed in a third example embodiment. In particular, FIG. 4 illustrates a user interface flow for a user making an express purchase. The process of FIG. 4 begins at block 400, where it determines whether the user is an authorized shopper. If so, a storefront home screen is presented in block 402; if not, a not authorized screen is presented in block 404. Example storefront home screens are described with respect to FIGS. 5A-5C, below.

From the storefront home screen of block 402, the user may manifest or indicate intent to purchase an item in at least three ways: (1) directly, (2) via a product details screen in block 406, or (3) via an artist's product list screen in block 408. Direct purchases and purchase via product details screens are further described with respect to FIGS. 5A-5C, below.

Upon manifesting intent to purchase an item, the process determines whether the user is a first-time buyer in block 410. If so, the user is presented with a first-time buyer information interstitial screen in block 412. An example first-time buyer interstitial screen is described with respect to FIG. 5C, below. After block 412, or if the user is not a first-time buyer, the user is presented with a thank you screen in blocks 414 or 415.

FIGS. 5A-5C are example user interface screens presented during example express purchases according to various embodiments. In particular, FIGS. 5A-5C show flows between user interface screens that are presented to users making various types of express purchases.

In the flow of FIG. 5A, the user is purchasing a ringback tone. The user begins at a storefront home screen 500. The screen 500 displays information about a ringback tone. The user can access a product details screen 502 by selecting the appropriate control (e.g., link) on the home screen 500. When the user selects a buy button on either the home screen 500 or the product details screen 502, the user is presented with a thank you screen 504. Note that the user did not need to enter any other authentication or registration information to purchase the ringback tone. From the thank you screen 504, the user can access a ringback tone management screen 506.

In the flow of FIG. 5B, the user is purchasing a mobile application. The user begins at a storefront home screen 510. When the user selects the Applications menu item on the screen 510 he is presented with an applications screen 512. The user can access a product details screen 514 by selecting the appropriate control (e.g., link) on the applications screen 512. When the user selects a buy button on either the applications screen 512 or the product details screen 514, the user is presented with a thank you screen 518. Note again that the user did not need to enter any other authentication or registration information to purchase the mobile application. From the product details screen 514, the user can also access a payment options screen 519 that enables the user to select a different payment mechanism, such as a credits club or wireless bill.

In the flow of FIG. 5C, the user is a first time buyer purchasing a music subscription. The user begins at a storefront home screen 520. When the user selects the Special Offers menu item on the screen 520 he is presented with an applications screen 522. When the user selects buy button 523, and if the user is a first time buyer, the user is presented with a first-time buyer interstitial screen 524. The screen 524 explains the express purchase facility to the user. In particular, the interstitial screen 524 informs the user that clicking a buy button always completes a purchase (without requiring additional input from the user); clicking a product title displays a product information page/screen; and that the price of the item is automatically added to the user's wireless bill unless the user specifies another payment mechanism. After the interstitial screen 524 is presented, the user is presented with a thank you screen 526 that includes information about managing the purchased music subscription, as well as cross-sell solicitations for related items.

The express purchase facility and mobile marketplace system described herein can in some embodiments be configured a number of ways to meet mobile carrier business needs, including:
1. Express purchase can be turned on/off globally or at a category level (e.g., on for Ringtones, off for Games).
2. Several options are available for first time vs. repeat experience.
   User sees a One-Time Interstitial explaining that the Buy button is immediate.
   An optional purchase confirmation page can be presented to a repeat user (configurable by category).
3. Optional purchase confirmation page can be used to present appropriate Terms and Conditions (“T&Cs”) per category (e.g., unique RBT T&C's).
4. Optional purchase confirmation page can be used to present appropriate billing implications (e.g., recurring charges for subscription purchases).
5. The Buy button for Express Purchase can appear:
   Within a product promotion (e.g., within a banner add on the shopping home page).
   Within a product promotional page (e.g., list of content for an event, seasonal, artist, brand, content provider, etc.).
   Within the product listings on any of the content category or sub-category pages (e.g., ringtones, graphics, games, applications, etc.).
   Within the tabbed merchandizing pages (e.g., “Hot”—most popular, “New”—most recent).
   Within the product preview page (e.g., graphic, audio, or video preview pages).
   Within the product details page.
   Within other on-deck or off-deck properties (e.g., banner ads on other carrier properties or 3rd party sites).
      1.0 mCORE Storefront Description

One embodiment, described further below, provides a mobile marketplace via a platform named the “mCore Platform.” Aspects of the described mCore Platform may be used to implement a MMS 100 described with respect to FIG. 1. The mCore Storefront is a component of the mCore Platform, which combines mobile Portal, Search and Storefront into a single, seamless user experience. By leveraging a unified Portal and Storefront solution, end customers benefit from consistent user experience. This includes consistent branding, style, navigation, search, device rendering, user segmentation and targeting, and simplified cross-promotion across properties. In addition, operators gain efficiencies and cost savings through shared tools and reporting features. The following sections outline the mCore Storefront and the various mCore tools utilized to efficiently manage the solution.

1.1 mCORE Storefront Components

The mCore Storefront includes the following components: Content On-boarding, Catalog Management, Merchandising, Discovery, Checkout, Billing, Delivery, Content Locker, Reporting, Reconciliation, and Customer Care.

1.2 Content on-Boarding

The mCore Storefront is built to deliver easy integration and maintenance to mobile content providers through secure interfaces. The mCore Platform provides a combination of technology, tools, testing, and services to ensure the efficient, high-quality presentation and delivery of content to users.

Content Submission Tool: Enables the uploading of content and associated meta-data into the mCore Content Warehouse, either by single item or bulk upload via a web services API. Content providers can view status of the content as it goes through the on-boarding and qualification process and receive notification of successful completion and any content errors. The binary can be hosted by the mCore Platform or a third party provider. New content types such as full track music and OS specific applications can be on-boarded without a code release but may require a code release if the content type needs a new delivery method.

Image Transformation Tool: Requires the upload of only a small set of source images to dynamically generate content size and format for all supported phones.

Audio Transformation Tool: Re-samples and reformats each piece of audio content into the specific content types required for each handset registered in the platform.

Video Transformation Tool: Re-samples and reformats each piece of video download into the specific content types required for each handset registered in the platform.

Content to Device Mapping Application (C2DMA): C2DMA technology uses a sophisticated rules-based algorithm to programmatically assign audio, video, and graphic content to on-boarded devices. C2DMA can be used in conjunction with the Transformation tools or standalone. C2DMA technology provides both the broadest content reach across devices and the highest level of quality, combining to ensure high customer satisfaction and return usage. Benefits of C2DMA include:
Reduced costs for content providers—Content providers no longer need to maintain devices mappings for their content.
Reduces need for content qualification—C2DMA programmatically determines the content attributes required to map content to devices. Used in conjunction with the Transformation tools yields a very high success rate, which greatly minimizes the need to qualify content plays or displays on a device.
Minimizes errors caused by manual mapping—C2DMA minimizes mapping errors by content providers. Devices are thoroughly tested as part of the onboarding process to verify devices capabilities are defined correctly.
Increases content availability for each device—C2DMA will go through each and every on-boarded device looking for any and all possible mappings to content.
Shortens on-boarding time of new devices—Content is available for a device as soon as it is on-boarded into the system. No need to wait for content providers to re-ingest content and mapping information.
Flexible to work with user needs—C2DMA can be enabled or disabled to suit needs and partnerships with content providers.

Tools: The mCore Storefront provides a set of Web-based tools that allow content providers to upload content through the APIs. Content Providers can also view real-time reports of the performance of each content item.

Testing: The mCore Platform automatically performs tests on content onboarded into the system to ensure the content follows operator rules as well as critical performance criteria for each handset and DRM. Testing (e.g., automated and/or human-driven), combined with a Handset profiling processes, ensure that operator subscribers consistently receive the highest quality content for each handset.

Device Profiling: the mCore Platform has a comprehensive device testing process to ensure users receive the best quality content, minimizing customer care complaints and increasing the probability of repeat purchase.

Services: the mCore Platform provides documentation and training for new content providers to ensure these providers are fully trained on all of mCore's APIs.

The mCore Storefront and its hosting environment are capable of handling millions of pieces of content and can be scaled to handle virtually any size content library from an ever-growing list of content partners. This capability gives operators the means to provide a wide offering that addresses the needs of the largest possible audience while giving content providers the confidence that their offerings are presented in the best possible light.

### 1.3 Catalog Management

The mCore Platform provides tools for operators to manage the content catalog. These encompass managing content provider information, defining rules for automating genre population, as well as correlating disparate content types/sources to generate a unique and compelling user experience.

Provider Manager: Enables operators to manage the list of Content Providers, along with associated metadata about that provider, associated URLs (if the storefront is to redirect to an externally hosted site), and any associated specific parameters that operators may desire to push to the destination URL (such as Parental Control settings).

License Manager: Stores relevant license information about specific Content/Application provider relationships. This information is versioned and used for settlement purposes.

Portfolio Manager: Allows operators to provide mappings from content provider metadata values to canonical values (e.g., genres) that can be used during the merchandising process. Changes to the metadata associated with content that exists in production can be published to production without requiring a complete republish of the entire taxonomy.

Catalog Manager: Enables taxonomy creation and association of content within the defined taxonomy.

### 1.4 Merchandising

The mCore Storefront provides flexible merchandising that can handle numerous pricing, packaging, and billing options. Through a convenient Web interface, operators can create new ways to package and bill end-users for content. Furthermore, operators can set rules within the Offer Manager to create and launch various pricing models available for set lengths of time (e.g., a Valentine's special on love songs for 1 week, extending a new billing option to specific segments of the user base).

Product Type Manager: Within mCore, pricing is associated with product types. Product types are associations of content based upon metadata. Assignment of Digital Rights Management (DRM) characteristics is also managed within this tool. With the creation of Product Types, operators are able to associate different pricing options with the same piece of content, (e.g., a full-track audio may be offered with DRM and without DRM at different price points).

Offer Manager: Pricing plans, such as bundles, subscriptions, and a la carte pricing are created via this tool, and associated with Product Types.

Redemption Manager: Enables operators to create and manage promotional offers such as gift cards, coupons, Short Codes, etc. Operators can use this tool to generate the codes associated with Tone Cards and Coupons; or bulk-upload these codes from an external source into the mCore Platform.

Promotion Manager: Enables operators to create promotions that display on the storefront, such as interstitials and promotional banners. Operators can define what should display within the promotion based upon device capabilities (e.g., text+link, image+link, etc.); as well as define when, where, how often and to whom a promotion should be displayed.

The Offer Manager supports the following pricing models:
Subscriptions: Can be created where users are billed each billing period for content and/or services. Several subscription types are supported:
Credit Subscriptions: Users receive a specific number of credits each billing period that can be spent on various pieces of content. Multiple subscription programs can be created within the storefront each with its own branding and set of rules.
Bucket Subscriptions: Users are given a certain number of downloads from one or more content types during each billing period (e.g., User gets 2 Music Tones, 2 premium graphics, and a game each month for a specific price).
Bundles: Two or more specific pieces of content are grouped together at a single price (e.g., user can buy Kanye West “Gold Digger” Music Tone and Graphic for $1.49; users are offered this bundle whenever they go to Product Page for Kanye West Gold Digger). Once created, bundles can be associated with specific artists or content.
Buy One and Receive Discount: Rules can be established that discount subsequent purchases within a specific time period. This feature can be used to create “buy one get one free” bundles and can be set so that the bundle only applies to certain content types (e.g., buy a game and get a ringtone for free, buy a game and get a second game of equal or lesser value for free, etc.).
Free Trials: Ability to set the price for a specific piece of content to “Free” to encourage download and usage.
Short Code Ordering: By adding this alternative, users can purchase content by sending an SMS message to a short code that includes a content code for a particular title. The mCore Storefront interprets the content code and returns the appropriate piece of content to the user and then facilitates the appropriate billing procedures. Delivery and billing methods support operator and industry standards (e.g., double opt-in) and enables traditional media interaction (e.g., print, radio, TV, online, etc.).
Stored Value Provisioning: Enables the creation of any number of stored value code programs that users can purchase content with (e.g., coupon codes, gift cards).

### 1.5 Discovery Interfaces

A variety of content discovery interfaces are provided, including a Mobile Storefront, a Web Storefront, and an API, as discussed below.

### 1.5.1 Mobile Storefront

Features of the mobile storefront include:
Full support for WAP 2.0
Intuitive and optimized purchase flow
Handset specific storefronts and content catalogs
Thoroughly tested user experience to ensure ease of use and minimize abandoned purchases
Powerful promotions that can create and place relevant content in front of receptive audiences
Templates for the efficient creation and deployment customized microstores
Device specific rendering based on device capabilities to ensure the most compelling user experience

### 1.5.2 Web Storefront

Consumers desire transparent pricing, ease of use, a broad catalog and a trustworthy vendor. The mCore Platform addresses these needs with a variety of Web storefront techniques including:
Makes available all features and capabilities available through the API with the flexibility for a completely custom Web UI as defined by the carrier.
Search tools that help users find exactly what they want
Powerful tools that minimize the merchandising/promotions overhead

### 1.5.3 Storefront APIs

For third-party developers, the mCore Storefront APIs provide a simple yet scalable means of creating unique storefronts based on Operator's content catalog. Through these storefronts, mCore provides users with new and attractive ways to access Operator's mobile content and services. In the format of Web Services, some of the available functions include:
Catalog Retrieval: Third party developers can quickly pull content and catalog structures through mCore Storefront APIs to create a storefront that can be used by an unlimited number of consumers to discover and purchase mobile content from Operator.
Content Search: Enables third party developers to search for user provided keywords within a specific content category or across all content categories.
Content Details: Provides content item specific details such as title, description, content type, price, etc.
Content Preview: Third party developers can utilize the content item preview method to locate and retrieve preview content media.
Order Processing: Facilitates the efficient purchase and fulfillment of mobile media. Through the APIs, third party developers can bill directly to subscribers monthly statement and deliver content to consumer devices.
User Purchase History: Enables the display of subscriber previously purchased content.
User Subscriptions: Enables the display of active subscriber subscriptions.
Order Status and Customer Service: the mCore Platform provides a base of tools for managing order status and customer service information, including tools with which customer service representatives can track every order from initiation to delivery. This increase in efficiency results in decreased hold times for customer service representatives and more satisfied customers.

### 1.6 Discovery Methods

### 1.6.1 Browse

The primary purchase path for the majority of users begins with browsing the storefront content catalog. Subscribers may start browsing at the storefront home page or may land directly on a specific content category or sub-category via an internal or external promotion (i.e. promotion within Portal).

The mCore Storefront user experience leverages product visual display, optimized purchase flows, user segmentation, content targeting, device optimization, and simplified purchase flows to improve the shopping experience and increase conversions.

The mCore Storefront browse path can be dynamically updated via the mCore catalog management and merchandising tools. Complex multi-tiered content taxonomies are supported. However, simplified taxonomies are recommended to reduce end user click distance.

### 1.6.2 Search

As more and more content becomes available to the mobile user, the need for strong search tools becomes increasingly important. Searching has become one of the most frequent activities on the Internet, second to only email and communications. mCore Search enables users to find the information they are looking for, reduce click distance and shopping cart abandonment and improve the overall mobile experience.

The mCore Platform provides a trusted white label source for a comprehensive, relevant, and customizable mobile search solution, capable of delivering multiple monetization models. mCore Search enables the efficient creation and management of custom dictionaries and content “aliasing”, an approach shown to increase sell thru and customer satisfaction in existing deployments.

By powering both Storefront and Portal, the mCore Platform provides an approach to relevancy that is not dependent on collecting data from other vendors. The relevancy algorithms take into account popularity, release date (aka freshness), third party top chart lists, price, and many other factors to produce the optimal result set.

The mCore Search product can be configured to utilize multiple structured content feeds as well as real-time content sources to create advanced search indexes. Result relevancy can be optimized for result recall (more results) or precision (few accurate results). In commerce applications, precision may be more important as the goal is to convert sales as quickly as possible. In addition, programmed “Direct Answers” can be provided via managed services to create editorial responses to specific keywords. For example, a search for “U2” can be programmed to return links to the artist page and latest ringtone and graphic.

Integration with 3rd party search providers is supported through Web services or a published search index.

### 1.6.3 Content Promotions

Content promotions enable mobile operators to drive mobile consumers to specific content categories, recently added content, specific content titles, or 3rd party advertising affiliates. Operators can define what should display within the promotion based upon device capabilities as well as define when, where, how often and to whom a promotion should be displayed.

Advertising Banners: mCore enables seamless integration with third party advertising providers. Targeted advertising is enabled via mCore provided content context, device capabilities, user specific demographics, and preferences.

Product Promotion Banners: Product promotions enable operators to direct mobile consumers to promotional content pages, content categories, or specific content titles.

Express Buy Promotions: Promotions for specific content titles that can be purchased directly from the promotion with one click. This streamlines the purchase process and reduces purchase flow abandonment.

Informational Pages: Educational promotions designed to explain new products, services, or features to subscribers. For example, an “Express Buy” notification can be provided to first time “Express Buy” users to explain that clicking on the “Buy” button immediately initiates a content purchase (no confirmation messages will be provided for future express purchases).

Promotional Content Pages: Promotional content pages are designed to promote artists, events, seasonal content, or specials. Promotional pages provide a description of the artist, event, content, or service with links to related content. Subscribers often arrive on promotional content pages by clicking on a link within a promotional banner

Micro-Stores: Micro-stores are designed to promote artists, events, seasonal content, or specials. Micro-stores include contextual promotions and an associated content catalog. Micro-store content catalogs may include content from multiple content types such as content bundles, ringtones, graphics, videos, games, etc.

Featured Promotion Links: Text link promotions that enable operators to direct mobile consumers to specific content categories or promotional content pages. For example, to promote a headliner artist of the week within the “Rock” ringtone category page.

Cross Promotion: mCore makes it efficient to create cross-promotions between the Portal, Storefront, and Search.

### 1.6.4 Content Recommendations

Content Recommendations provide another method of content discovery. A recommendations engine presents content items (e.g., ringtones, graphics, games, applications, content bundles, etc.) that are likely of interest to mobile consumers. Content recommendations leverage content based and collaborative filtering methods as well as explicit and implicit data points (e.g., user properties and user behaviors) to provide targeted content recommendations.

Content recommendations may be provided across multiple content providers or content types. mCore recommendations include:
Similar Content Recommendations: Similar Content Recommendations suggest content and artists similar to those a user is currently viewing (e.g., a user viewing an Akon song might see recommendations for songs by 50 Cent and Ludacris). This approach ensures that even users who have no history with the storefront are immediately shown how to quickly navigate to most relevant content, thereby increasing the likelihood of user purchases.
Operator Weightings: Through the recommendations solution, operators are able to weight the responses of the recommendation engine to support their business objectives.

In addition to improved usability and page views, use of the mCore Recommendation Engine results in increased customer retention and higher conversion rates with new and established users alike.

### 1.6.5 User Content Ratings

Users have an opportunity to provide ratings of content they have purchased based on a five star rating system. Each piece of content can be rated only once by a user, however, the user can return to their “My Downloads” page to see their ratings for all downloaded content and change their ratings an unlimited number of times. These ratings are aggregated and displayed for each piece of content within the storefront.

### 1.7 Checkout

At checkout users may have more than one option to purchase content. The default method for purchase is using credits if there are any associated with the user's account. If the user's credits balance is zero then the default would be to add the charge for the content to the user's bill. The mobile UI displays the default purchase method and shows both price and credits available at checkout. Users may also select a link to view other purchase options that include using stored value codes such as coupon cards. Users may also be presented with up-sell and cross-sell options at checkout. If a user wants to purchase content with credits but does not have enough available, they may purchase small incremental sets of credits or upgrade to the next higher subscription level and receive the difference in credits immediately in order to complete the purchase. The express purchase option utilizes the default purchase method and can be utilized to streamline the purchase process to one click.

### 1.8 Billing

The mCore Storefront enables multiple billing methods that can be configured by individual content items and by content type. For carrier billing mCore can be integrated with the carrier's preferred billing provider. Billing methods available today include: Carrier billing, Subscription clubs, and/or Stored value redemption.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “includes,” “including,” “comprises,” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

All of the above-cited references, including U.S. Provisional Application No. 61/406,898 entitled “EXPRESS PURCHASE SYSTEMS AND METHODS” and filed Oct. 26, 2010, are incorporated herein by reference in their entirety. Where a definition or use of a term in an incorporated reference is inconsistent or contrary to the definition of that term provided herein, the definition of that term provided herein governs and the definition of that term in the reference does not apply.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

1. A method of providing a mobile marketplace to a mobile device having an associated user, the method comprising:
receiving an indication that the mobile device has accessed the mobile marketplace;
causing the mobile device to display information about an item that is available for purchase via the mobile marketplace;
receiving an indication of a single action performed by the user, the single action manifesting the user's intent purchase the item;
determining, without receiving additional registration or log-in information from the user, a billing service configured to process payments for transactions initiated by the user;
causing the billing service to process a payment for the item; and
providing the item to the mobile device for access by the user.

2. The method of claim 1, further comprising:
receiving a user identifier associated with the user; and
authenticating the user based on the received user identifier.

3. The method of claim 1, wherein causing the mobile device to display information about the item includes transmitting the information about the item to the mobile device.

4. The method of claim 1, wherein causing the mobile device to display information about the item includes causing the mobile device to display information about at least one of: a ringtone, a song, a video and a computer program.

5. The method of claim 1, wherein
determining the billing service includes identifying a subscription account associated with the user; and
causing the billing service to process the payment includes recording a charge to the subscription account and causing the charge to appear on a monthly bill transmitted to the user.

6. The method of claim 1, wherein
determining the billing service includes identifying a pre-paid account associated with the user; and
causing the billing service to process the payment includes decrementing the pre-paid account.

7. The method of claim 1, wherein
determining the billing service includes identifying a subscription club account associated with the user; and
causing the billing service to process the payment includes decrementing credits from the subscription club account.

8. The method of claim 1, wherein determining the billing service includes automatically determining a subscription account, a pre-paid account, or a subscription club that is linked to an identifier associated with the user.

9. The method of claim 1, further comprising facilitating single-action purchases without any of: account pre-registration performed by the user, account log-in performed by the user, and credit-card information received from the user.

10. The method of claim 1, wherein receiving the indication of the single action includes receiving an indication that a user interface control was selected by the user, the user interface control being at least one of a link, a button, a menu item, a device motion, an accelerometer, or a gesture.

11. The method of claim 1, wherein
the item is a tangible good offered for sale by a retail entity; and
causing the billing service to process the payment includes billing the user via a wireless service account bill.

12. The method of claim 1, wherein the item includes at least one of: an application, a game, a ringtone, a ringback tone, a wallpaper, a video, a user interface theme, a content bundle, a carrier service, an event ticket, or a travel ticket.

13. The method of claim 1, wherein the item includes a physical good that is at least one of: an item of clothing, a storage medium, an electronics item, a food item, or a beverage.

14. A computer-readable medium including contents that enable a computing system to provide a mobile marketplace to a mobile device having an associated user by performing a method comprising:
receiving an indication that the mobile device has accessed the mobile marketplace;
causing the mobile device to display information about an item that is available for purchase via the mobile marketplace;
receiving an indication of a single action performed by the user, the single action manifesting the user's intent purchase the item;
determining, without receiving additional registration or log-in information from the user, a billing service configured to process payments for transactions initiated by the user;
causing the billing service to process a payment for the item; and
providing the item to the mobile device for access by the user.

15. The computer-readable medium of claim 14, wherein the computer-readable medium is a memory in a mobile computing device.

16. The computer-readable medium of claim 14, wherein the contents are instructions that, when executed, cause the computing system to perform the method.

17. A computing system configured to provide a mobile marketplace to a mobile device having an associated user, comprising:
a memory;
a processor; and
a module stored on the memory that is configured, when executed by the processor, to:
receive an indication that the mobile device has accessed the mobile marketplace;
cause the mobile device to display information about an item that is available for purchase via the mobile marketplace;
receive an indication of a single action performed by the user, the single action manifesting the user's intent purchase the item;
determine, without receiving additional registration or log-in information from the user, a billing service configured to process payments for transactions initiated by the user;
cause the billing service to process a payment for the item; and
provide the item to the mobile device for access by the user.

18. The computing system of claim 17, wherein the module includes software instructions for execution by the processor of the computing system.

19. The computing system of claim 17, wherein the module is a mobile marketplace manager module.

20. The computing system of claim 17, wherein the module is configured to provide a mobile marketplace to at least one of a personal digital assistant, a smart phone, a laptop computer, a features phone, a quick messaging device, a multimedia phone, a netbook, a tablet computer, a network connected computing device, a home automation device, and/or a third-party application.
